(19) United States
(12) Patent Application Publication
(10) Pub. No.: US 2006/0046641 A1
(43) Pub. Date: Mar. 2, 2006

(54) Screen protection apparatus equipped with character information transmission function

(75) Inventors: David Ho, Sanchung City (TW); Tony Tsai, Hsinchu (TW); Ming-Hua Wang, Shanghai City (CN)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 10/930,750

(22) Filed: Sep. 1, 2004

(51) Int. Cl. H04H 7/00

(52) U.S. Cl. 455/3.06

(57) ABSTRACT

A screen protection apparatus equipped with character information transmission and calendar memo function is located in a mobile communication device. It includes a condition setting module, a display module, an information storing module, an information access module, a timer and a switch module. The condition setting module aims to set the mobile communication device in a screen protection state. The display module aims to display a protection picture on the display screen of the mobile communication device. The information storing module stores a plurality of information. The information access module accesses information in the information storing module when the mobile communication device is in the screen protection state, and display the protection picture on the display screen. The timer measures a switch time according to a preset time interval. The switch module switches the information in the information storing module when the switch time is due to allow the information access module to access the information thereafter.

### FIELD OF THE INVENTION

The present invention relates to a screen protection apparatus equipped with character information transmission and calendar memo information functions and particularly to a screen protection apparatus and method adopted for use on mobile communication devices to sequentially present a plurality of character information and calendar memo information through protection pictures.

### BACKGROUND OF THE INVENTION

Mobile communication devices are very popular these days, and information may be transmitted at a fast speed. A mobile communication device displays the received information to the user of the mobile communication device. The mobile communication device generally has a display screen to display pictures and characters to present the received information to the user.

With the information transmission function of the mobile communication devices becomes more powerful, a wide variety of multimedia information have been transmitted and received. The display screen of the mobile communication devices also has great improvements. Their performance and efficiency are higher, color is brighter, resolution is higher, response time is faster, reliability increases, and viewing angle is greater. As a result, the screen also is more expensive. Hence special protection measures have been employed to protect the delicate and precise display screen of the mobile communication device.

Refer to FIG. 1 for a conventional screen protection apparatus 1 adopted for use on a mobile communication device. When the mobile communication device is in an idle condition, the screen protection apparatus 1 sets the display screen in a screen protection state. A protection picture is displayed on the display screen. The protection picture constantly switches or the display picture alters constantly to avoid the screen to be burned by the same color and luminosity at the same location continuously and result in aging of the entire display screen and uneven display, and diminishing of the display effect. This is especially important for the color display screen. The conventional screen protection apparatus 1 includes a condition setting module 2, a display module 3, a graphic data storing module 4, a data access module 5, a timer 6 and a switch module 7.

The condition setting module 2 aims to set the mobile communication device in a screen protection state. The display module 3 aims to control the display screen to display a protection picture when the mobile communication device enters the protection state. The protection picture constantly switches or alters. The graphic data storing module 4 stores in advance a plurality of graphic data such as scenery, people, and the like.

The data access module 5 sequentially accesses the graphic data from the graphic data storing module 4 through the switch module 7 when the condition setting module 2 has set the mobile communication device in the screen protection state. The accessed graphic data are displayed on display screen of the mobile communication device through the display module 3 in the protection picture format. As shown in FIG. 2, the timer 6 measures a switch time according to a preset time interval. When the preset time interval has elapsed, the timer 6 determines the switch time is due, and the switch module 7 sequentially switches the graphic data in the graphic data storing module 4 to allow the data access module 5 to access the graphic data thereafter.

However, the conventional screen protection state is a simple switch of the pictures of scenery, people, patterns and the like. As shown in FIG. 2, while it has an amusing effect, it does not transmit information that is an important function to the mobile communication device. Hence such an apparatus does not have much added value to the mobile communication device.

### SUMMARY OF THE INVENTION

Therefore the primary object of the invention is to provide a screen protection apparatus which is capable of transmitting character information and has calendar memo functions to increase the added value of the mobile communication device. The screen protection apparatus according to the invention can sequentially display a plurality of protection pictures on the display screen of the mobile communication device that contain information. Hence the user of the mobile communication device can get more valuable information from the mobile communication device. Besides the function of simply transmitting messages, it also enables the mobile communication device to equip educational and information management functions. Thus it can increase the added value of the mobile communication device.

The screen protection apparatus according to the invention is located in a mobile communication device. It includes a condition setting module, a display module, an information storing module, an information access module, a timer and a switch module. The condition setting module aims to set the mobile communication device in a screen protection state. The display module aims to control the display screen of the mobile communication device to display a protection picture. The information storing module stores a plurality of information. The information access module aims to access the information in the information storing module when the condition setting module has set the mobile communication device in the screen protection state, and display the accessed information on the display screen of the mobile communication device through the display module. The timer measures a switch time according to a preset time interval. The switch module switches the information in the information storing module when the switch time is due to allow the information access module to access the information thereafter.

Thus the screen protection apparatus and method according to the invention can sequentially display the protection pictures that contain information on the display screen of the mobile communication device. Thereby users of the mobile communication device can get information such as English character information, Japanese character information, calendar and memo information, and the like that have a greater value. Hence besides allowing the mobile communication device to provide a simple information transmission function, it also provides educational and information management functions to increase the added value of the mobile communication device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional screen protection apparatus.

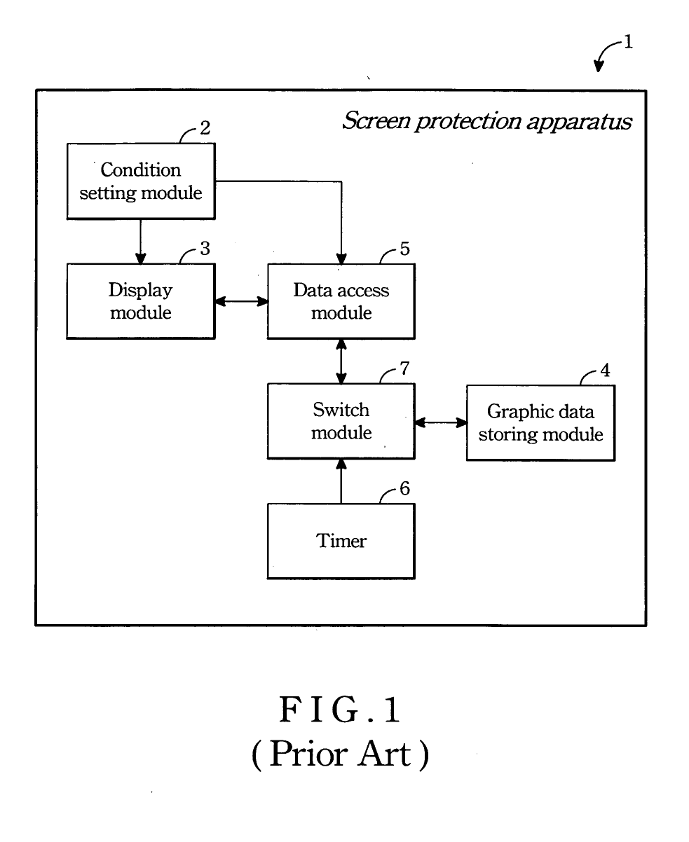

FIG. 2 is a schematic view of a protection picture of a conventional mobile communication device.

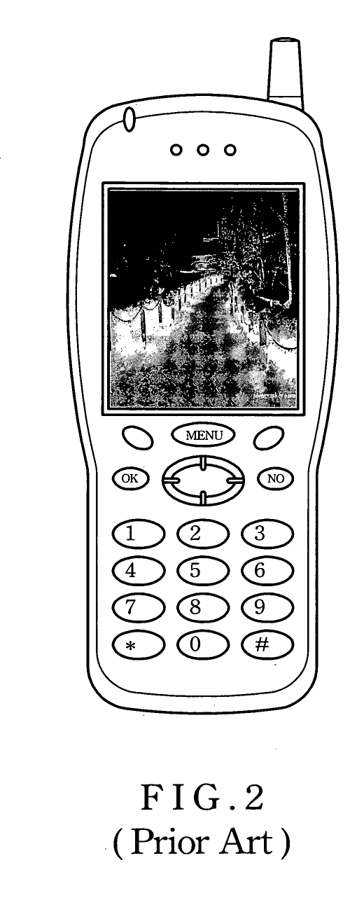

FIG. 3 is a schematic view of the screen protection apparatus of the invention.

FIG. 4 is a schematic view of a protection picture of the mobile communication device according to the invention.

FIG. 5 is a schematic view of the invention for processing calendar memo information.

FIG. 6 is a process flow of an embodiment of the invention.

### DESCRIPTION OF THE PREFERRED EMBODIMENTS

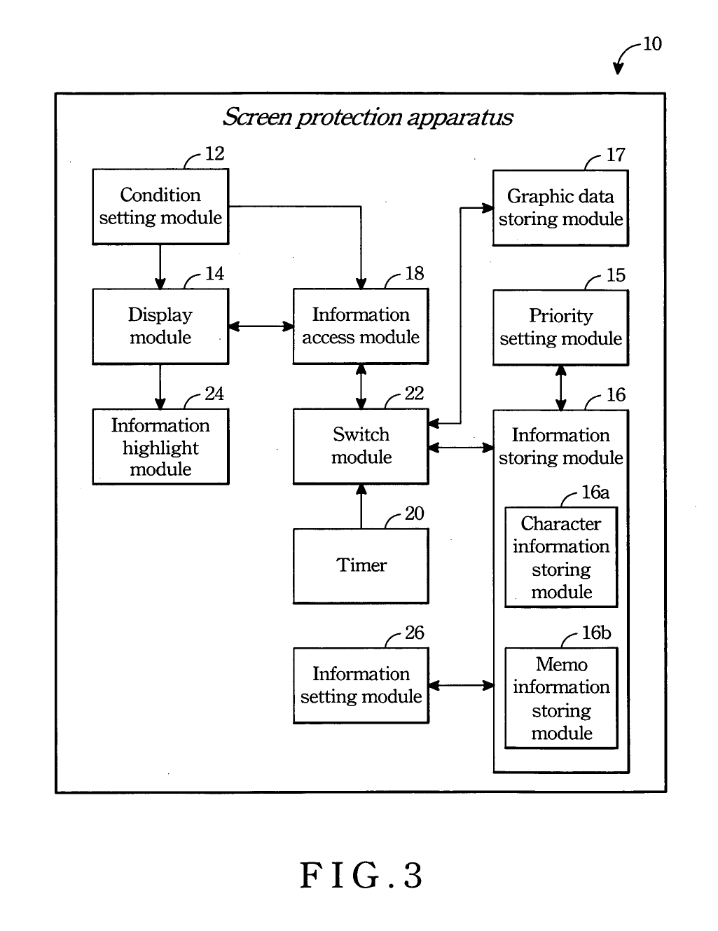

Referring to FIG. 3, the screen protection apparatus 10 according to the invention is adopted for use on a mobile communication device to transmit character information and provide calendar memo functions. It includes a condition setting module 12, a display module 14, a priority setting module 15, an information storing module 16, a graphic data storing module 17, an information access module 18, a timer 20, a switch module 22, an information highlight module 24 and an information setting module 26.

The condition setting module 12 aims to set the mobile communication device in a screen protection state. When the mobile communication device has not been used for a period of time, the condition setting module 12 determines that the mobile communication device is in an idle condition and sets the mobile communication device in the screen protection state. The display module 14 aims to control a display screen of the mobile communication device to display a protection picture when the mobile communication device is in the screen protection state. The protection picture is continuously switched or altered.

The information storing module 16 stores a plurality of information in advance that include English character information, Japanese character information or calendar memo information, and the like. Depending on the information type, the information storing module 16 may include a character information storing module 16a and a memo information storing module 16b to store respectively English character information, Japanese character information and calendar memo information. The graphic data storing module 17 is like the conventional one for storing graphic information such as scenery pictures, people pictures, and the like. Before the function of the invention is activated, the screen protection apparatus 10 will function as a conventional one to retrieve graphic data from the graphic data storing module 17 and display on the display screen of the mobile communication device in a protection picture fashion.

The priority setting module 15 aims to set the importance priority of the information in the information storing module 16 to be referred to by the switch module 22 in the follow on processes.

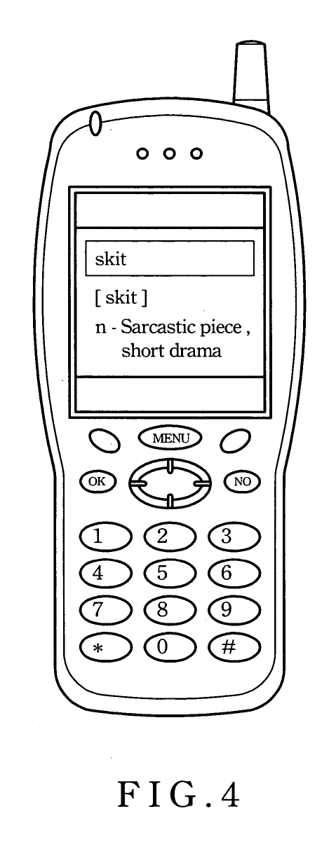

The information access module 18 sequentially accesses the information from the information storing module 16 through the switch module 22 when the condition setting module 12 has set the mobile communication device in the screen protection state, and displays the accessed information on the display screen of the mobile communication device through the display module 14 in the protection picture fashion. Referring to FIG. 4, the information access module 18 accesses English characters from the character information storing module 16a and display on the display screen of the mobile communication device in the protection picture fashion. The timer 20 measures a switch time according to a selected time interval. Each time the selected time interval has elapsed, the timer 20 determines the switch time is due, and the switch module 22 switches sequentially a plurality of information in the information storing module 16 to allow the information access module 18 to access the information thereafter.

The switch module 22 may switch the information randomly or according to the preset importance priority of the information, such as the higher priority information have a higher probability of appearing. This can improve the function. For instance, for a character information that is difficult to remember and important calendar memo information, their importance priority may be set higher through the priority setting module 15 so that they have a greater chance of appearing. The priority setting module may be designed as a simple button to facilitate operation on the mobile communication device.

The information highlight module 24 generates alert by an audio signal when the preset information is displayed on the protection picture, or by blinking the protection picture, or by changing the display color of the protection picture to remind the user of the mobile communication device. In general, it is used on more important information, especially the calendar memo information or character information which the user cannot remember.

The information setting module 26 aims to modify the information in the information storing module 16, such as altering the old character information in the character information storing module 16a, or adding and deleting the calendar memo information in the memo information storing module 16b. After the information setting module 26 has modified the information, through the information switching principle of the switch module 22, the modified information may be switched according to the sequence of modification time. Based on previous discussion, the display module 14, information access module 18, character information storing module 16a and information setting module 26 provide the function of an electronic dictionary now being used.

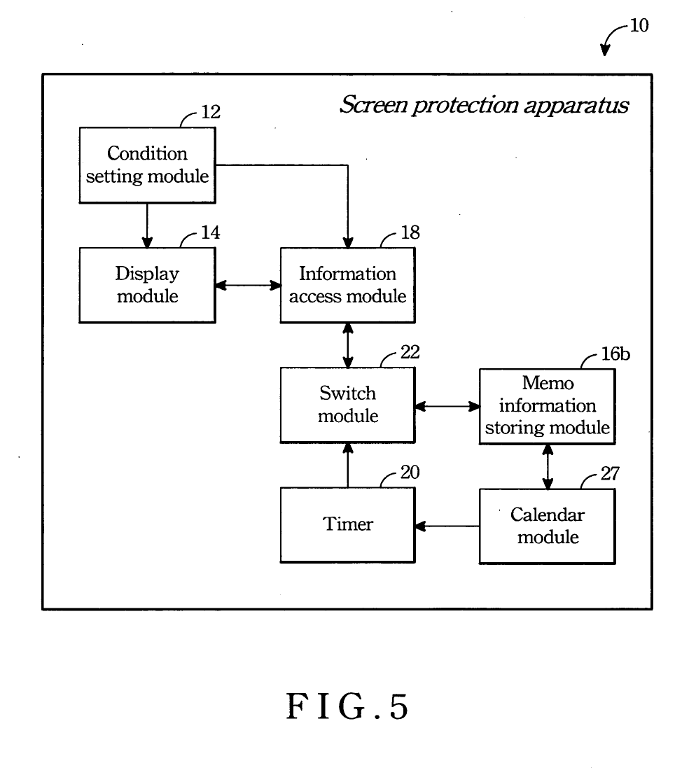

Refer to FIG. 5 for more details of the screen protection apparatus 10 in calendar memo information processing. It may further include a calendar module 27. After the condition setting module 12 has set the mobile communication device in the screen protection state, the calendar module 2 detects the preset calendar due time and couples with the timer 20 for the next switch time to display the calendar memo information stored in the memo information storing module 16b in the protection picture fashion. It also may be coupled with the switch module 22 to switch the information randomly or according to the information importance priority, and allow the data access module 18 to access the calendar information thereafter and display the calendar memo information through the display module 14 in the protection picture fashion. The information highlight module 24 may also be used to alert the user. From the previously discussion based on FIG. 5, it indicates that the display module 14, information access module 18, memo information storing module 16b and the calendar module 27 provide the function of a PDA now being used.

The invention also provides a screen protection method equipped with information transmission function for a mobile communication device. Based on the screen protection apparatus 10 previously discussed, the screen protection method of the invention includes the following steps:

First, determine that the mobile communication device has not been used for a period of time, and is in an idle condition; set the display screen of the mobile communication device in a screen protection state; next, display a protection picture on the display screen of the mobile communication device; switch a plurality of information in the information storing module 16 according to a preset time interval; then access sequentially selected information to be switched in the information storing module 16 that may be English characters, Japanese characters, or calendar memo information, and the like.

Then display the accessed information on the display screen of the mobile communication device in the protection picture fashion. The information switch principle may be random or according to a preset importance priority of the information.

When the preset information among the multiple information appears on the protection picture, an audio signal may be generated, or the protection picture may be blinked, or the color of the protection picture may be changed to alert the user of the mobile communication device. In general, This is to target the important information, especially the calendar memo information or characters that user has difficulty to remember.

The method set forth above may further include altering the information in the information storing module 16, such as changing the old character information in the character information storing module 16a, or adding and deleting the calendar memo information in the memo information module 16b. After the information have been altered by the information setting module 26, the information may be switched according to the information switch principle by the altering time sequence of the information.

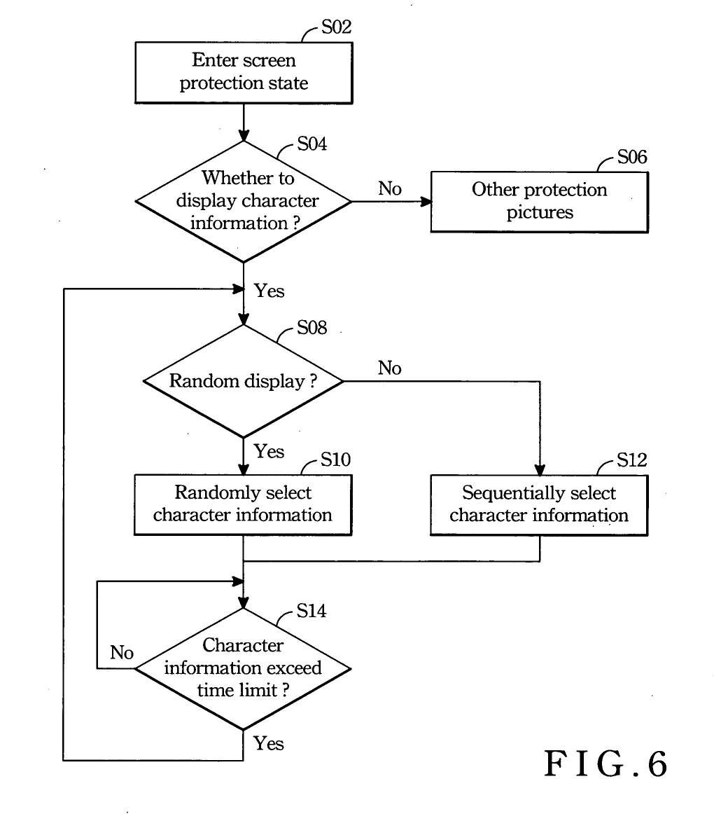

Refer to FIG. 6 for a process flow of an embodiment for displaying character information protection picture. First, step S02, determine that the mobile communication device has not been used for a period of time and idled; set the display screen of the mobile communication device in a screen protection state, and display a protection picture of the display screen; step S04, determine whether to display the protection picture by English characters or Japanese characters, if negative, go to step S06 to display a general protection picture such as a scenery picture and the like; if positive, display the character information on the display screen, and go to step S08 to determine whether to display randomly; if positive, go to step S10, randomly select the character information; if negative, go to step S12, sequentially select the character information, such as by the original storing sequence or character strokes; step S14, switch a plurality of information in the information storing module 16 according to a preset time interval. If the displaying character information exceed the preset time interval, continuously access the information from the information storing module 16.

Thus the screen protection apparatus equipped with information transmission function 10 can sequentially display protection pictures containing a plurality of information on the display screen of a mobile communication device. Therefore users of the mobile communication device can get information such as English character information, Japanese character information, calendar memo information and the like that have a greater value. Thereby the mobile communication device, besides simply transmitting information, also has educational and information management functions. Thus the mobile communication device has a greater added value.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A screen protection apparatus equipped with information transmission function being located on a mobile communication device, the information containing at least one character information, the apparatus comprising:
a condition setting module for setting the mobile communication device in a screen protection state;
a display module to control a display screen of the mobile communication device to display a protection picture when the mobile communication device is in the screen protection state;
an information storing module for storing a plurality of information;
an information access module for accessing the information in the information storing module when the mobile communication device is in the screen protection state and displaying the information and the protection picture on the display screen through the display module;
a timer for measuring a switch time according to a preset time interval; and
a switch module for switching the information in the information storing module at the switch time measured by the timer to allow the information access module to access the information thereafter.

2. The screen protection apparatus of claim 1 further including an information highlight module to generate an audio signal when a selected information in the information storing module appears on the protection picture.

3. The screen protection apparatus of claim 1 further including an information highlight module to blink the protection picture when a selected information in the information storing module appears on the protection picture.

4. The screen protection apparatus of claim 1 further including an information highlight module to change the color of the protection picture when a selected information in the information storing module appears on the protection picture.

5. The screen protection apparatus of claim 1, wherein the information in the information storing module include calendar memo information.

6. The screen protection apparatus of claim 1, wherein the switch module switches the information randomly.

7. The screen protection apparatus of claim 1, wherein the switch module switches the information according to a preset information importance priority.

8. The screen protection apparatus of claim 7 further including a priority setting module to set importance priority of the information in the information storing module.

9. The screen protection apparatus of claim 1 further including an information setting module to modify the information in the information storing module.

10. The screen protection apparatus of claim 8, wherein the switch module switches the information according to the modification time sequence of the information.
